(19) United States
(12) Patent Application Publication
(10) Pub. No.: US 2026/0113691 A1
(43) Pub. Date: Apr. 23, 2026

(54) WIRELESS TELECOMMUNICATIONS NETWORK ACCESS MANAGEMENT

(71) Applicant: T-Mobile USA, Inc., Bellevue, WA (US)

(72) Inventor: Gaviphat Lekutai, Kirkland, WA (US)

(21) Appl. No.: 18/923,296

(22) Filed: Oct. 22, 2024

(51) Int. Cl. H04W 48/06; H04W 84/06

(52) U.S. Cl. CPC H04W 48/06; H04W 84/06

(57) ABSTRACT

Described herein are systems and methods for optimizing wireless telecommunications networks. Some implementations relate to automatically managing capacity by adjusting beamforming configurations. Some implementations relate to optimizing service provided by both terrestrial and non-terrestrial networks. In some implementations, the systems and methods herein optimize handoffs from a terrestrial network to a non-terrestrial network. In some implementations, the systems and methods herein regulate access to a non-terrestrial network.

### BACKGROUND

Cellular networks can provide connectivity for wireless devices such as smartphones, tablets, hotspots, smartwatches, wireless high speed internet gateways, and so forth. Non-terrestrial networks such as balloon-based networks, aircraft-based networks, or satellite-based networks can provide similar functionality. Terrestrial and non-terrestrial networks can have different advantages and disadvantages, which can influence circumstances under which each type of network may be preferred.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a diagram that illustrates various aspects of a system according to some implementations.

FIG. 4 is a diagram that illustrates an example of terrestrial network coverage gaps and non-terrestrial coverage according to some implementations.

FIG. 5 is another diagram that illustrates an example of terrestrial and non-terrestrial coverage according to some implementations.

FIG. 6 is a diagram that illustrates an example of TN and NTN coverage according to some implementations.

FIG. 7 is a flowchart that illustrates an example process for adjusting beamforming according to some implementations.

FIG. 8 is a flowchart the illustrates an example process for predictive beamforming according to some implementations.

FIG. 9 is a flowchart that illustrates an example process for optimized handoff to a non-terrestrial network according to some implementations.

FIG. 10 is a flowchart that illustrates an example process for determining a scanning frequency according to some implementations.

FIG. 11 is a flowchart that illustrates an example process for disabling cell sites in an area according to some implementations.

FIG. 12 is a flowchart that illustrates an example process for enabling NTN access in a geofenced area according to some implementations.

FIG. 13 is a block diagram that illustrates components of a computing device.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

Terrestrial networks (TNs) such as ground-based cellular networks and non-terrestrial networks (NTNs), such as satellite networks and high altitude platform systems (e.g., using balloons or unmanned aerial vehicles), can each be used to provide wireless communications services. However, there are significant differences between TNs and NTNs. Cellular networks rely on terrestrial infrastructure (e.g., cell towers, base stations, wired backhaul connections, etc.), while NTNs have less reliance on ground-based infrastructure or the specific placement of ground-based infrastructure. For example, for a satellite network, parabolic dish antennas on the ground can be used to communicate with geostationary satellites, or phased array antennas can be used to communicate with low earth orbit satellites and/or medium earth orbit satellites. In some cases, cellular user equipment (e.g., smartphones) includes hardware for connecting to satellite networks.

NTNs can more easily cover a larger geographic area as there is no need to deploy ground-based infrastructure in remote or sparsely inhabited regions. However, NTNs have several drawbacks compared with terrestrial cellular networks. For example, NTNs such as satellite networks typically have higher latency due to longer propagation distances, provide lower data speeds, and cost significantly more to deploy and operate than cellular networks. NTNs may have less capacity than terrestrial networks, and increasing capacity can be expensive compared to adding terrestrial capacity. Thus, it can be desirable to rely on cellular networks when available, while utilizing NTN (e.g., satellite) networks when cellular coverage is not available or to provide additional capacity when cellular networks are under heavy load, such as during sporting events, concerts, or disasters.

Satellite NTNs can operate in various manners. In some cases, geostationary satellites can be used. Geostationary satellites can be appealing because they can provide reliable, consistent coverage in an area. However, geostationary satellites require relatively high altitude orbits (e.g., about 42,000 km from the center of earth), which can result in significant latency. For example, at the equator, a typical latency can be 240 ms or more as a signal travels from the surface of earth to the satellite and back. This presents a significant problem for real-time or low latency communications, such as voice calls, video conferencing, online gaming, and so forth. Another option is to use low earth orbit satellites. Low earth orbit (LEO) satellites can have significantly lower latency than geostationary satellites as they are positioned much closer to the surface of earth, for example about 2,000 km above the surface, and can be suited to real-time or nearly real-time tasks such as voice calls, video conferencing, etc. However, LEO satellites are in constant motion with respect to the surface of earth, and thus the area covered by an LEO satellite changes over time. Clusters of LEO satellites can be used to provide wider and/or more consistent coverage, but coverage in a particular area still changes over time and may not always be available. Additionally, even where satellite coverage is available, the specific satellites that are available changes over time as different satellites move in orbit around earth.

The constant movement of LEO satellites with respect to the ground creates significant challenges for wireless communications. In some cases, there may be multiple LEO satellites available, and it can be beneficial to choose the best available satellite, which can depend on a variety of factors such as available capacity, throughput, how long the satellite will be available (e.g., how long the satellite will provide coverage in an area), etc. As satellites move in and out of an area, data transmission can be handed off to other satellites. Handoff between low earth orbit satellites can introduce significant technical complexity on both the part of the satellite network and a device (e.g., user equipment such as a smartphone, tablet, watch, hotspot, etc.) that is connected to the satellite network. Handoffs can result in service interruptions, increased battery consumption, and so forth, as a device searches for or attempts to establish a connection with a different satellite.

NTNs may also be more significantly impacted by weather conditions that can block or interfere with radio signals. Obstructions in the line of site to a satellite can also impact connectivity, throughput, error rates, etc. For example, NTN service may not work well inside buildings, when there is dense forest cover, when there are buildings or natural features in a line of sight between a user device (e.g., a smartphone) and a satellite, and so forth. The performance and availability of both non-terrestrial and terrestrial wireless networks can depend upon the particular frequency or range of frequencies used.

To provide improved service (e.g., greater geographic coverage or better network availability during times of high load on cellular infrastructure), it can be advantageous for user equipment to be able to communicate via both terrestrial networks and non-terrestrial networks. Providing NTN service, however, can be associated with a significant cost and has various technical limitations, for example as described herein. Thus, it may generally, though not always, be preferable to have users communicate via cellular infrastructure rather than satellite infrastructure whenever cellular infrastructure is available. Additionally, when user equipment does use an NTN for communication, it can be significant to take performance, availability, and so forth into consideration, for example, when selecting a satellite of an LEO satellite network.

In some implementations, user equipment roams onto an NTN when outside a cellular coverage range, for example in rural areas, national forests, national parks, lakes, oceans, and so forth. In some implementations, user equipment roams onto an NTN whenever a cellular network is experiencing capacity issues, such as during maintenance, when there are problems with cell sites, when a large number of users are gathered in an area and place heavy demands on terrestrial infrastructure, etc. Coordinating and managing connections to TNs and NTNs can be challenging, as the two network types are typically separate entities and may be owned and/or controlled by different companies. In some implementations, data from user equipment capable of connecting to both TNs and NTNs is provided to an artificial intelligence/machine learning (AI/ML) model to enable network planning and optimization for both terrestrial and non-terrestrial networks. For example, combinations of locations, times, and other parameters of user equipment when connected to non-terrestrial coverage can feed into a model to optimize cellular and non-terrestrial networks to, for example, enable more seamless handovers, provide better beamforming coverage, reduce latency, improve battery life on user equipment, better use available spectrum, and so forth. In some implementations, data from satellites, cell sites, or both are fed into the model. For example, satellite and/or cell site data can indicate total capacity, available capacity, network quality issues, number of devices connected, etc.

As described herein, in some implementations, one or more artificial intelligence/machine learning (AI/ML) models are used to optimize the use of cellular networks and NTNs. In some implementations, information about cellular and NTN usage is used to make beamforming decisions for a cellular network, for example to provide improved coverage in certain areas. In some implementations, the approaches described herein are used to achieve more efficient handover from TN to NTN and vice versa. In some implementations, the approaches described herein are used to conserve power on a mobile device by, for example, optimizing satellite search frequencies. In some implementations, the approaches described herein are used for geofencing to define geographic areas where devices may or may not connect to a satellite or other non-terrestrial network. Each of these is described in more detail herein.

Some implementations described herein use machine learning to optimize the usage of terrestrial and non-terrestrial networks. A model, as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision tree forests (e.g., random forests), and others. Models can be configured for various situations, data types, sources, and output formats.

In some implementations, a model includes a neural network with multiple input nodes that receive input data such as cellular network usage data, satellite network usage data, weather data, event data (e.g., data about upcoming sporting events, festivals, concerts, gatherings, etc.), and so forth. The input nodes can correspond to functions that receive the input and produce results. These results can be provided to one or more levels of intermediate nodes that each produce further results based on a combination of lower-level node results. A weighting factor can be applied to the output of each node before the result is passed to the next layer. At a final layer (the “output layer”), one or more nodes can produce a value relating to the input that, once the model is trained, can be used to, for example, predict terrestrial network utilization, time to destination, outage reason, non-terrestrial network utilization, and so forth. In some implementations, such networks, known as deep neural networks, can have multiple layers of intermediate nodes with different configurations, can be a combination of models that receive different parts of the input and/or input from other parts of the deep neural network, or are convolutions - partially using output from previous iterations of applying the model as further input to produce results for the current input.

A machine learning model can be trained using supervised learning, where training data includes inputs and a label indicating a desired output. A representation of the input data can be provided to the model. Output from the model can be compared to the desired output for that input and, based on the comparison, the model can be modified, such as by changing weights between nodes of the neural network of parameters of the functions used at each node in the neural network (e.g., applying a loss function). After applying each of the inputs in the training data and modifying the model in this manner, the model can be trained to evaluate new inputs.

The approaches described herein can have significant advantages over other, manual or naïve approaches to managing the utilization of terrestrial and non-terrestrial networks. For example, the approaches describe herein can enable better utilization of terrestrial and non-terrestrial networks, resulting in an overall improvement in network performance and/or reliability for wireless users, fewer outages, fewer capacity issues, and so forth. The approaches herein can, additionally or alternatively, be used to better manage terrestrial networks, such as by enabling or disabling terrestrial cell sites based on predicted demands. Advantageously, the methods herein can operate in both proactive and reactive manners, as described herein.

### Beamforming Optimization

Beamforming is a significant technology that can be used to improve performance in cellular and other wireless networks. Unlike omnidirectional broadcasting, beamforming can manipulate the spatial domain of radio waves, directing radio signals toward specific areas. Beamforming can be accomplished using phased array antennas, in which multiple antenna elements are arranged in a specific pattern to achieve better coverage in certain areas. For example, by controlling the phase and amplitude of the signal from each element of the array, a pattern can be defined that focuses radio signals in a particular direction or directions. This can be effective for improving coverage or capacity in some areas, but can come at the expense of reduced coverage in other areas.

There are several beamforming techniques commonly used in cellular networks. Using multiple-input multiple-output, a large number of antenna elements at a base station can be used to generate one or multiple directional beams. Digital beamforming can utilize signal processing algorithms to adjust the phase, amplitude, or both of signals transmitted from each antenna element. In some cases, digital beamforming can be used to dynamically adjust radio signals based on current needs, channel conditions, and so forth.

Beamforming can allow for better coverage as beams can be focused on a particular group of users or to a particular area. Additionally or alternatively, beamforming can provide improved throughput, as focusing carrier waves can increase a signal to noise ratio, decrease interference, and so forth. Typically, wireless telecommunication providers utilize beamforming to provide coverage toward dense populations. In some cases, RF engineers can focus the best available coverage (e.g., 5G coverage) on a populated area, while providing reduced service (e.g., 4G coverage) to more sparsely populated areas. As older cellular technology is retired, TN-based coverage in sparse areas can decline significantly or even be eliminated entirely. In some cases, NTNs can be used to provide coverage in areas where TN coverage has been eliminated (or where TN coverage never existed). For example, in a rural area at a cell edge boundary of a 5G base station, the base station can focus its beamforming coverage toward a direction that is more densely populated or where there is greater demand for cellular service, while unfocused areas can use NTN coverage. As another example, in and around marine environments (e.g., lakes), base stations can focus coverage on the land while leaving the water or parts of coastal land areas to be covered by an NTN.

Conventional approaches to beamforming are largely static. That is, RF engineers determine where to focus coverage, and the beamforming configuration can remain largely fixed, possibly with occasional, manual updates when significant coverage gaps are observed, for example during network testing. Conventional approaches can work well in some circumstances, such as where usage locations are fairly constant over time and there is little daily or seasonal variation. However, there can be significant drawbacks to such static, manual approaches. People may move around, gather in different areas, and so forth. For example, a ski resort may be largely empty in some months but very busy other times of the year. Lakes, small towns, and other places used for recreation may have relatively low demands during the week but significantly higher demands on weekends or holidays.

Demand can vary based on time of day (e.g., there may be less demand in suburban areas during working hours), season, weather (e.g., if it is raining on a Saturday, a park that normally sees a lot of weekend visitors may see few, if any, visitors). Some areas that rarely experience significant demand may see a significant increase in demand if, for example, a festival is hosted in the area. Accordingly, there is a need for approaches to determining beamforming configurations that can more readily adapt to actual or expected utilization.

In some implementations, data from user equipment, base stations (e.g., 5G base stations), and/or NTN satellites is used to train a model to determine optimized beamforming directions. Training data can include, for example, time, location, reference signal received power (RSRP), downlink throughput, uplink throughput, data usage, modulation coding scheme (MCS), block error rate (BLER), signal to interference plus noise ratio (SINR), interference level, congestion level, and so forth. In some implementations, a system is be configured to train a model for static planning, for example when determining deployment for new cell sites. In such cases, the system can use long term data that can span days, weeks, months, or years. In some implementations, a model is be provided with real time or nearly real time data, which can enable dynamic beamforming that is responsive to current network demands. As an example, beamforming may focus coverage on a commercial area during working hours and may focus coverage on residential areas in the evenings or on weekends.

In some implementations, beamforming decisions are made proactively, for example using predictive information such as weather forecasts, information about upcoming scheduled events, and/or the like. In such cases, beamforming adjustments can be made before users begin connecting to an NTN. For example, information about upcoming events (e.g., sporting events, concerts, etc.) can be provided to the model, and beamforming can be optimized to provide improved coverage at the time and location of events. In some implementations, weather information is used for beamforming decisions. For example, if rain is expected on the weekend, there may be little need to provide coverage to an outdoor recreation area, or if significant snowfall is expected during the week, it can be expected that a nearby ski resort will be busy on the weekend. It will be appreciated that a predictive model does not need to know specific details about locations. For example, a machine learning model may not be provided with information indicating the location of a ski resort, but rather can determine that a particular location sees increased demand when there is significant snowfall. In some implementations, a model is provided with information about the locations of certain facilities or destinations, such as ski resorts, beaches, sporting arenas, parks, and so forth. This can be significant, for example, for predicting an increased demand in a particular location where an event is to be held, or for predicting increased demands around new facilities or destinations where there may be little or no historical data available.

In some implementations, a system is configured to automatically revert beamforming adjustments. For example, if proactive beamforming changes are made in anticipation of an event, the beamforming changes can be scheduled to revert once the event ends. For example, if a concert or sporting event is being held, the start time and expected duration can be known or estimated and used to determine when to revert the beamforming.

In some implementations, a system is configured to determine beamforming changes based on the presence of satellite users in a particular location. For example, devices can be configured to automatically connect to an NTN when unable to connect to a terrestrial network and/or when terrestrial network performance drops below a threshold level (e.g., a minimum throughput). In some implementations, the system evaluates various criteria for adjusting beamforming. For example, beamforming adjustments can depend on the feasibility of providing coverage in the particular location, the impact on nearby areas, etc. In some cases, an area may be too far from cell towers for beamforming adjustments to be used to provide terrestrial coverage at all or to provide terrestrial coverage with suitable capacity, throughput, etc. For example, if there are many devices on an NTN in an area, but beamforming can only effectively be used to provide terrestrial service to a small number of those devices, there may be limited benefit to making beamforming adjustments.

In some cases, the system considers the impact on nearby areas. For example, when beamforming is adjusted at a cell site, areas that previously received a first level of coverage from the cell site can experience a second, reduced level of coverage. This impact can be significant if a cell site is already at or near capacity, or would be at or near capacity if beamforming adjustments are made. In such cases, it may be desirable not to make beamforming adjustments, as doing so could have a discernible negative impact on users who normally experience good coverage. In some cases, a wireless telecommunications provider may want to maintain a threshold level of excess capacity, and adjusting beamforming can negatively impact the excess capacity in an area.

In some implementations, after making beamforming adjustments, a system is be configured to monitor demand for the terrestrial network within the geographic area. In some implementations, beamforming adjustments are reverted once demand drops below a threshold level. In some implementations, beamforming adjustments are reverted once demand drops below a threshold level for at least a threshold period of time. Alternatively, beamforming adjustments can be reverted based on demand predicted by an AI/ML model. While in many cases, thresholding can be used to effectively determine when to revert beamforming changes, in some cases it can be advantageous to use an AI/ML model to predict more precisely when demand for TN coverage in the geographic area has dropped and is likely to remain sufficiently low such that beamforming adjustments are no longer warranted. Such a determination can depend on a wide variety of factors, such as current demand in the geographic area, current demand in areas serviced by nearby cell sites, predicted demand in the geographic area, predicted demand in the areas serviced by nearby cell sites, and so forth.

As an example, even though demand in the geographic area remains high, it may be desirable for a wireless telecommunications operator to revert or partially revert beamforming adjustments to provide better service outside the geographic area, for example based on a predicted demand for TN service outside the geographic area. As an example, if coverage is typically focused on a busy highway, it can be desirable to revert beamforming so that commuters have good coverage during rush hour.

In some implementations, a system is configured to monitor neighboring cell sites whose coverage areas at least partially overlap with cell sites whose beamforming has been adjusted. If demand on those neighboring cell sites exceeds a maximum value, beamforming changes can be reverted or modified to reduce demand on the neighboring cell sites.

### Terrestrial and Non-terrestrial Network Handover Optimization

User equipment can experience a significant power cost when switching between cellular and satellite networks. For example, significant power can be consumed when searching for a cell tower or satellite to connect to. If connection quality is poor or a line of site between a user's device and a satellite is interrupted, the device may search for another satellite to connect to, consuming yet more power. In some cases, a device's connection to a cellular network may be interrupted for only a short period of time, in which case it may be desirable to not attempt to establish a satellite connection. Efficient handover between cellular and non-terrestrial networks can be particularly important for devices such as smartphones, which have limited battery capacity.

In some implementations, an AI/ML model is configured to determine which of a plurality of satellites is best to connect to based on various criteria such as, for example, signal strength, throughput, latency, location, and/or time of day. In some embodiments, the model is configured to identify a satellite or base station to connect to based on the movement of user equipment. For example, in some implementations, a trajectory prediction (e.g., a predicted path) is used to select handover parameters such as which satellite to connect to, which base station to connect to, and/or when to perform a handover operation, in order to minimize service interruptions, total number of handovers, and so forth. As an example, if a user is traveling north and satellites are traveling south, it can be desirable to connect to a northernmost available satellite to maximize the amount of time that the user's device can stay connected to the same satellite. It will be appreciated that this is merely a simple illustrative example, and in practice many other factors, for example, as described herein, can be used to determine which satellite of a cluster of satellites to connect to.

In some implementations, the AI/ML model is trained using data that includes, for example, satellite ID, base station ID, time, location, RSRP, radio resources, spectrum, noise level, SINR, MCS, congestion level, and/or other data. In some implementations, input sources for data can include, for example, user equipment, serving base stations, neighboring base stations, satellites, and so forth. In some implementations, input data is determined from various sources. For example, data can come from multi-systems operators, core network infrastructure, and so forth. In some implementations, feedback from the model enables efficient handover of user equipment between satellites, base stations, or both.

In some implementations, when a cell site is down, congested, has low signal coverage, or otherwise provides a poor connection, or when cell service is not available along a portion of a user's route, the model or another model is used to suggest a new route (e.g., detour) for the user equipment to travel while maintaining a target service level. For example, in some implementations, a system determines a current route for a device. The route can be predicted using an AI/ML model, can be provided by a user (e.g., the user may enter a destination into the device), etc. For example, a user can use a navigation application on a device such as a smartphone to input a route. In some implementations, a machine learning model predicts a route based on historical travel patterns of a user. In some implementations, a machine learning model predicts the route based on historical travel patterns of a plurality of users. In some implementations, both approaches are used, or an approach can be selected based on the user's location. For example, if a user is near home or work, their own historical travel patterns can be a strong indicator of their likely destination. If a user is far from frequently-visited locations, there may be little or no historical travel pattern information available for the user. In such cases, it can be desirable to utilize historical travel patterns of other users to predict the user's route. It will be appreciated that rerouting recommendations can generally be more reliably when a user's destination is known, but predicted routes may still be useful in some circumstances.

In some implementations, an AI/ML model predicts when and/or where user equipment is moving. In some implementations, the model can be used to set scanning and/or periodicity thresholds in order to conserve user equipment power.

In some implementations, scanning and/or periodicity thresholds are set at least in part based on a battery level of a device. In some implementations, the model can determine that no scanning should be performed. For example, if a user is moving into a building, satellite scanning can be paused while there is no line of sight. In some implementations, if battery power is low, scanning can be set to occur at a lower frequency so that a user's device has sufficient power to remain operational until the user arrives at their destination or a location where the device can be recharged.

As an example, searching for satellite coverage can be paused when a device is in an obstructed location and has no line of site to an NTN, for example when in a building, subway, heavy forest, tunnel, stacked highway, etc. In some implementations, whether the user is an obstructed location is based on mapping or other information that indicates the locations of tunnels, heavy forest cover, buildings, etc. In some implementations, location is determined based on, for example, triangulation of cell signals. In some implementations, location is determined based on satellite navigation data, such as GPS data. GPS data can, in some cases, be accurate to within a few meters, and specialized GPS equipment can be used to determine location with centimeter-level precision. GPS accuracy can be influenced by several factors, such as satellite geometry (e.g., the positions of GPS satellites relative to one another), atmospheric conditions, multipath effects (e.g., signals bouncing off buildings or other large objects), or obstructions. GPS accuracy can be determined in various manners and using various metrics. For example, metrics can include position dilution of precision, horizontal dilution of precision, or vertical dilution of precision. Signal quality indicators, such as the number of satellites in view and their signal strength can indicate GPS accuracy. This information can be used to determine if, for example, a device is located in an area with poor satellite coverage. For example, if there are few or no GPS satellites in view or their signal strength is weak, this can indicate that the user is in a covered or otherwise obstructed area. Thus, in some implementations, NTN scanning can be paused or performed less frequently when GPS location cannot be determined accurately.

In some implementations, scanning frequency is based at least in part on power level. In some implementations, multiple scanning frequencies are defined for multiple threshold battery levels. For example, if the battery level is below 10%, scanning can occur every 5 seconds; if the battery level is below 25%, scanning can occur every 2 seconds; if the battery level is below 50%, scanning can occur every 1 second; if the battery level is below 75%, scanning can occur every 0.5 seconds. If the battery level is at or above 75%, scanning can occur every 10 milliseconds. It will be appreciated that this is merely an example, and the number of thresholds, values of the thresholds, and/or scanning frequencies associated with each threshold can be different.

In some implementations, time to destination is used alternatively or additionally to determine a scanning frequency. For example, if a user is far from their destination and/or has low battery, the scanning frequency can be relatively low, while it can be higher if the user is close to their destination and/or the battery level is high. In some cases, a user may not have a clear destination or the destination may be unknown, in which case time to destination may not be considered when determining a scanning frequency.

In some implementations, a destination is determined based on a destination provided by the user. For example, a user may use navigation software or other software to input a destination. In some implementations, software on a user device can be configured to use the destination, estimated time of arrival, etc., when determining a scanning frequency. In some implementations, a system is configured to predict, for example using a machine learning model, a destination, estimated time of arrival, etc., based on past travel data of the user device. For example, if a user frequently visits certain locations or visits locations on certain days, times of the year, etc., this information can be used to predict a past destination that the user is likely to be headed to. For example, cellular geolocation logs can be used to predict travel patterns based on previously-observed travel.

In some implementations, a user's geographic location is used to determine, at least in part, a scanning frequency. For example, if a user is stranded in a thick forest or on a remote mountain, it can be important to preserve power, in which case, the scanning frequency may be set low, for example every 30 minutes, every hour, every two hours, etc.

While described herein largely with reference to handoffs between terrestrial and non-terrestrial networks, it will be appreciated that the approaches herein can be applied, additionally or alternatively, to handoffs between terrestrial networks or between non-terrestrial networks. For example, when a subscriber to a wireless telecommunications provider travels outside a coverage area of the wireless telecommunications provider, the subscriber's device can roam onto a competitor network. While roaming can offer many benefits, such as ensuring coverage even in areas outside the wireless telecommunication provider's coverage area, seamlessly continuing calls or data transfers, etc., there can be significant disadvantages associated with roaming. For example, significant battery power can be used when a device searches for signals from an available network. If connectivity is lost, there can be increased data usage when a device roams onto a competitor network, for example as background services on the device attempt to synchronize or otherwise communicate with servers, for example to upload photos, download music or podcasts, retrieve e-mail or other messages, and so forth. In some cases, a user may only be outside of the wireless telecommunications provider's coverage area for a limited amount of time, or roaming coverage may only briefly be available. In such cases, it can be advantageous to avoid attempting to roam onto a competitor network, as doing so may confer little or no benefit to the user while consuming limited battery resources, potentially causing significant data charges to be incurred, etc.

### Non-terrestrial Network Geofencing

In some implementations, an AI/ML model is used to determine geofencing for NTN access. Geofencing can be used to deny access to an NTN, to permit access to an NTN, to instruct user equipment to only connect to an NTN, and so forth. For example, as described herein, it can typically be desirable to keep user equipment on a terrestrial network whenever a terrestrial network is available in order to limit usage of an NTN, which can have significant costs. Geofencing can be used to limit access to an NTN and/or to allow access to an NTN under certain circumstances, for example based on terrestrial network available, network demands, regulatory considerations, etc. As an example, a geofence can be used around countries or regions where local laws or regulations do not permit accessing satellite networks.

Use of an NTN can be desirable when there is very low load on cell sites. For example, when cell sites are underutilized or otherwise experience very low load (e.g., at night), a model can be configured to create a geofenced area. Within the geofencing area, user equipment may not scan for a cellular network and may instead scan only for a non-terrestrial network. It can be desirable, for example, to shut down cellular sites to conserve energy when there is little or no demand. It can be significant to update such geofenced areas periodically or in real time or nearly real time, as the usage of a cell site can vary significantly throughout the day, on different days, etc. For example, a cell site in a remote recreational area may see little or no usage during the workweek, during periods when weather would discourage people from traveling to the area, and so forth.

In some implementations, geofenced areas are defined based on high usage, when an NTN can be used to provide additional capacity. As an example, in populated areas with good cellular coverage, user equipment may ordinarily not scan for NTN coverage. However, when there is a period of high usage (e.g., during a sporting event, show, disaster, etc.), a geofence can be set up in the high usage area, and devices in the area can connect to an NTN. In some cases, devices can scan for an NTN when cellular coverage is present but overloaded.

In some implementations, thresholds are set for high load and/or low load to limit when geofences are created. As an example, low load can be defined as occurring when resource block utilization is less than 5% or about 5% for a two-hour period, or high load can be defined as occurring when resource block utilization is at or above 95% or about 95% for a one hour period. The specific utilization thresholds and time thresholds can vary. In some implementations, time thresholds are not used. However, time-based thresholds can be significant as they can prevent disabling or enabling access to an NTN during brief periods of decreased or increased utilization.

### Wireless Communications System

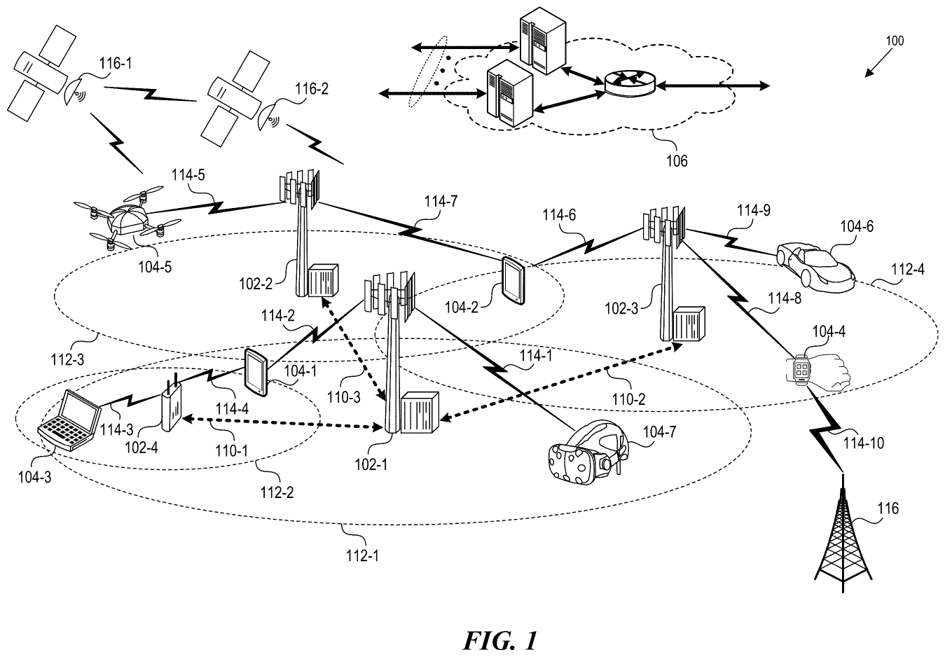

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 902.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., 31 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

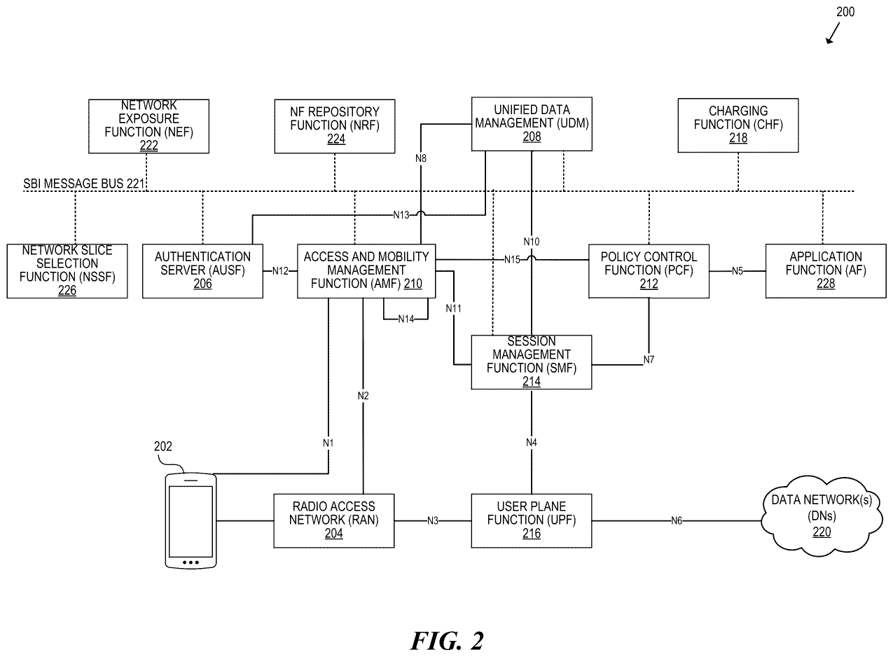

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### EXAMPLE EMBODIMENTS

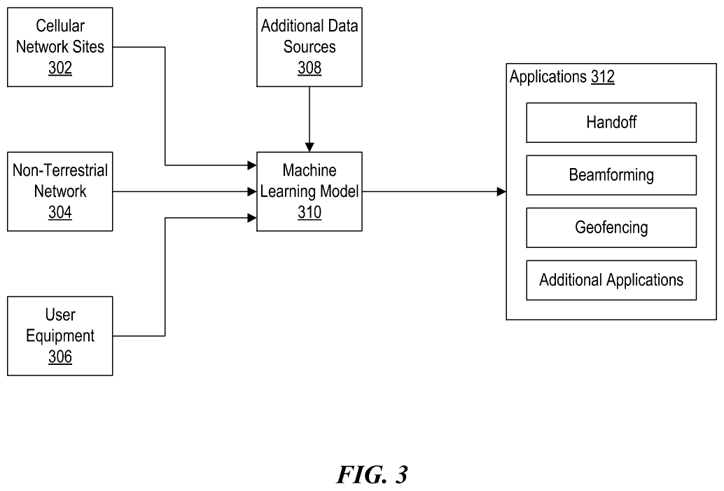

FIG. 3 is a diagram that illustrates various aspects of a system according to some implementations. In FIG. 3, data can be provided to a machine learning model 310, and the output of the machine learning model 310 can be used in various applications 312. The applications 312 can include, for example and without limitation, handoff, beamforming, and/or geofencing. For example, a handoff application can involve determining optimized handoff strategies for transitioning between a terrestrial and non-terrestrial network, or between different terrestrial networks or different non-terrestrial networks.

In some implementations, the machine learning model 310 is configured to determine an output based on various inputs. Inputs can come from a variety of sources, including, for example, cellular network sites 302, a non-terrestrial network 304, user equipment 306, and/or additional data sources 308. For example, cellular network sites 302 can provide information about capacity, location, signal strength, coverage area, interference, etc. A non-terrestrial network 304 can provide information about available satellites, satellite travel paths, satellite travel speeds, capacity, etc. Such information can be used to determine, for example, whether there are satellites available to connect to, which available satellite offers the best capacity, which available satellite offers the longest coverage time, etc. For example, as described herein, since low earth orbit satellites are in constant motion with respect to the surface of earth, the particular satellites that are available, if any, can vary over time. An available satellite can be disfavored if, for example, it will only be able to provide coverage for a short period of time before moving out of a line of site with respect to a user device. User equipment 306 can provide information such as remaining battery life, location, location accuracy, movement, destination, etc., which can inform whether or not to attempt to connect to a non-terrestrial network, which satellite to connect to, etc.

Additional data sources 308 can include, for example, information about events, weather, holidays, etc. As described herein, event data and/or weather data can be used in identifying areas that are likely to have a relatively high or relatively low population of devices. Such information can be used to make decisions such as whether or not to disable terrestrial cellular equipment, whether or not to temporarily allow satellite connections in a geofenced area where satellite connections are typically not permitted (e.g., near a stadium during a sporting event or concert), and so forth.

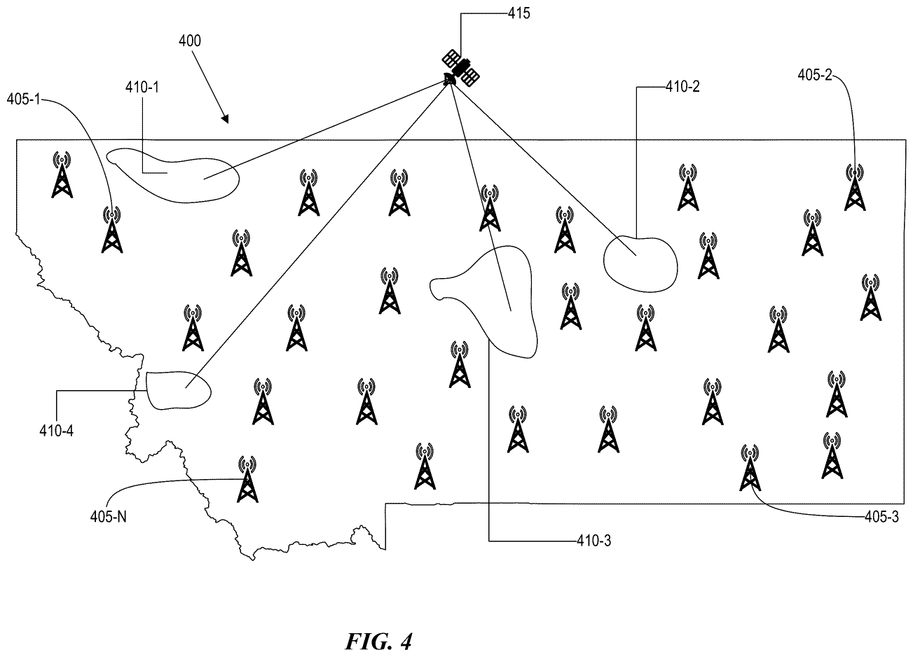

FIG. 4 is a diagram that illustrates an example of terrestrial network coverage gaps and non-terrestrial coverage according to some implementations. In FIG. 4, terrestrial cellular coverage is provided in a geographic area 400 by cellular sites 405-1 to 405-N. There are coverage gaps 410-1-410-4 (collectively, coverage gaps 410) in the geographic area 400. The coverage gaps 410 can be covered by a satellite 415. The satellite 415 can be part of a satellite network. While one satellite is depicted in FIG. 4, there can be more than one satellite that provides coverage to the geographic area 400, and different satellites can provide coverage within the geographic area 400 at different times, for example in the case of LEO satellites.

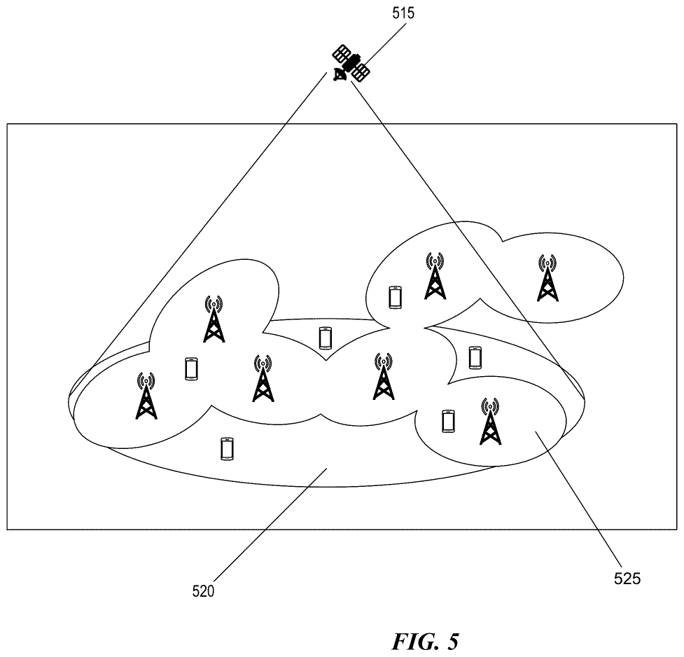

FIG. 5 is another diagram that illustrates an example of terrestrial and non-terrestrial coverage according to some implementations. As shown in FIG. 5, a satellite 515 can provide a coverage area 520. The coverage area 520 can overlap with a coverage area 525 provided by terrestrial cell sites. When a user device is within a coverage area of a cell site, the user device can connect to the cellular network. When a user device moves outside of cellular coverage, the user device can connect to the satellite 515.

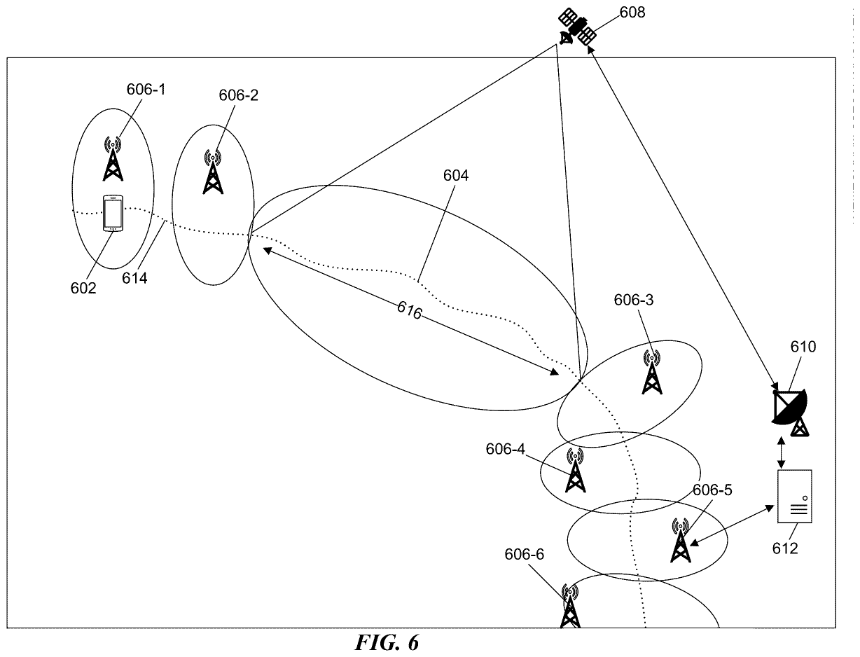

FIG. 6 is a diagram that illustrates an example of TN and NTN coverage according to some implementations. In FIG. 6, a device 602 (e.g., a smartphone) is traveling along a path 604 (dotted line). TN coverage is provided by cell sites 606-1 - 606-6 (collectively cell sites 606). The cell sites 606 do not provide coverage along the entire length of the path 604. A satellite 608 can provide coverage in areas where the cell sites 606 do not provide coverage. While one satellite 608 is illustrated in FIG. 6, it will be appreciated that multiple satellites can provide coverage. The satellite 608 can be connected to a ground-based receiver 610. The ground-based receiver 610 and the cell sites 606 can be in communication with a system 612, which can be used for AI/ML training, determining handoff conditions, etc. In FIG. 6, only the cell site 606-5 is illustrated as being connected to the system 612, but any and/or all cell sites 606 can be connected to the system 612, either directly or indirectly.

As shown in FIG. 6, there is a gap 614 between the coverage provided by the cell site 606-1 and the cell site 606-2. As shown in FIG. 6, satellite coverage is not provided in the gap 614, for example because the gap 614 is relatively small so a time that the device 602 is expected to be within the gap 614 may be too short to justify consuming battery power and other resources to connect to an NTN. The satellite 608 can provide coverage within the gap 616, which is large enough that the device 602 can be expected to remain within the gap 616 for a significant period of time.

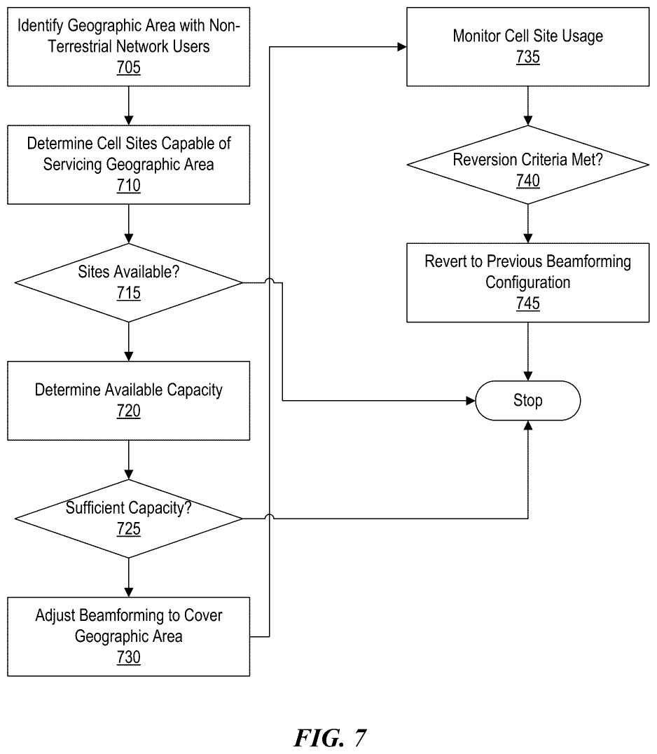

FIG. 7 is a flowchart that illustrates an example process for adjusting beamforming according to some implementations. At operation 705, a system can identify a geographic area with devices that are connected to a non-terrestrial network. In some implementations, the system identifies a geographic area with at least a minimum number of devices connected to a non-terrestrial network. The determination can be based on information received by the system from the NTN network, from devices connected to the NTN network, or both. At operation 710, the system can determine if there are cell sites capable of servicing the geographic area. For example, cell sites may not be capable of servicing the geographic area if they are too far away, blocked by natural or manmade obstructions, and so forth. At operation 715, if there are sites available, the process can continue. If not, the process can stop and the devices can remain on the NTN. At operation 720, the system can determine available capacity of the cell sites. In some cases, beamforming adjustments may only be made if there is sufficient capacity to adjust beamforming without reducing service levels in a regularly-covered area by more than a maximum amount or if beamforming adjustments will not result in loads above a threshold amount. At operation 725, if there is not sufficient capacity, the process can stop. If there is sufficient capacity, the system can instruct one or more cell sites to perform beamforming adjustments such that the cell sites can provide coverage within the geographic area at operation 730.

At operation 735, the system can monitor usage at the cell sites where beamforming adjustments were performed. For example, the system can monitor usage within the geographic area, outside the geographic area, or both. The system can use any combination of one or more specified criteria to determine whether to revert to the previous beamforming configuration. For example, if demands outside the geographic area rise beyond a threshold level, the system can revert all or some of the cell sites to their prior beamforming configurations. If demands inside the geographic area drop below a threshold amount, the system can revert the cell sites (or some of the cell sites) to their prior beamforming configurations. In some implementations, beamforming reversion is performed if demands within the geographic area drop below a threshold amount for at least a minimum amount of time or if demands outside the geographic area exceed a threshold amount for at least a minimum amount of time. At operation 740, the system can determine if the applicable reversion criteria are met. If not, the system can continue to monitor cell site usage. If so, the system can revert one or more cell sites to their prior beamforming configuration at operation 745.

In some embodiments, beamforming adjustments may be unable to render the terrestrial network capable of providing significant service to the geographic area. For example, there can be an obstacle (e.g., an unknown obstacle) that prevents the cell site from providing service within the geographic area. In such cases, the system can determine that fewer than a threshold number of devices are connected to the cell site from within the geographic area and can either adjust beamforming of the cell site again to attempt to provide service within the geographic area or can revert to the previous beamforming configuration for the cell site.

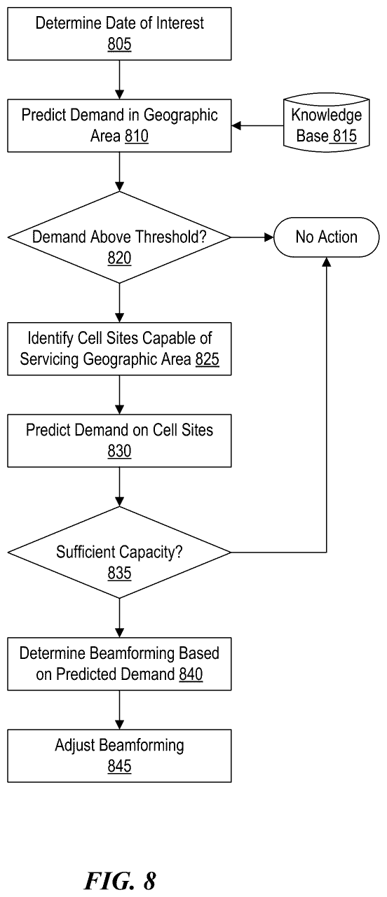

FIG. 8 is a flowchart the illustrates an example process for predictive beamforming according to some implementations. The process shown in FIG. 8 can be used to proactively determine beamforming adjustments. Proactive determination can be desirable for multiple reasons. For example, proactive beamforming can reduce or eliminate connections to an NTN by users in a geographic area, as terrestrial coverage can be provided in the geographic area before there is a demand for coverage.

At operation 805, a system can determine a date of interest. For example, a user can provide a date of interest or a system can be configured to automatically determine a date of interest or multiple dates of interest, such as the next day, next week, next ten days, next two weeks, next month, etc. At operation 810, the system can predict demand in a geographic area using a machine learning model, such as the machine learning model described with reference to FIG. 3. In some implementations, the system accesses a knowledge base 815. The knowledge base 815 can be used to determine, for example, predicted weather, scheduled events, etc., that occur on the date of interest. In some implementations, the knowledge base is used to determine if the date of interest falls at a weekday, weekend, or holiday. At operation 820, the system can determine if the predicted demand is above a threshold value. If not, the system can take no action. If so, the system can identify cell sits capable of servicing the geographic area at operation 825. At operation 830, the system can predict demand on the cell sites. The predicted demand can include demand inside the geographic area and demand outside the geographic area but within an area covered by the cell sites. In some implementations, the system determines a spatial distribution of the demand, which can help to inform beamforming optimization. At operation 835, the system can determine if there is sufficient capacity at the cell sites to modify beamforming. For example, the system may only modify beamforming if service outside the geographic area will not deteriorate beyond an acceptable level or if beamforming adjustments are capable of providing at least a minimum level of service inside the geographic area. If, at operation 835, the system determines that there is not sufficient capacity, the system may take no action. If, at operation 835, the system determines that there is sufficient capacity, the system can, at operation 840, determine one or more beamforming adjustments based on the predicted demand. At operation 845, the system can adjust beamforming at one or more cell sites. In some implementations, beamforming adjustments are made soon (e.g., immediately) after the adjustments are determined. In other implementations, beamforming adjustments are scheduled. For example, adjustments can be scheduled to be made shortly before an event, holiday, etc. In some implementations, reversions are scheduled automatically. For example, if beamforming is adjusted to provide better weekend coverage, the adjustments can be automatically reverted at the end of the weekend (e.g., Sunday night).

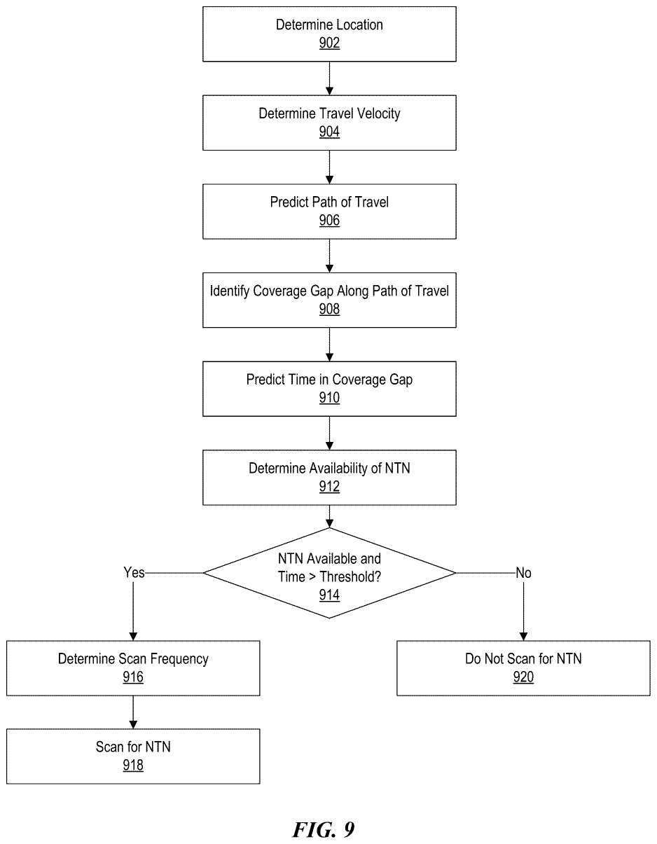

FIG. 9 is a flowchart that illustrates an example process for optimized handoff to a non-terrestrial network according to some implementations. The process can be executed on a user device (e.g., a smartphone) or on another system, which can transmit instructions to the user device for connecting to the NTN. At operation 902, a system can determine a current location of a user device. The location can be determined by, for example, GPS or cellular triangulation. At operation 904, the system can determine a travel velocity (e.g., a direction of travel and a speed of travel), for example based on a difference between a first position of the user device at a first time and a second position of the user device at the second time. At operation 906, the system can predict a path of travel of the device. For example, the system can provide information such as the current location and travel velocity to a machine learning model that is trained to predict a path of travel. In some implementations, the machine learning model uses an identifier of the device or an identifier of a user associated with the device, which can enable the model to consider the particular travel patterns associated with the device. At operation 908, the system can identify a coverage gap along the predicted path of travel. For example, network coverage information can be used to determine locations where cellular coverage is unavailable along the predicted path of travel. At operation 910, the system can predict a time that the device will be within the coverage gap, for example based on a size of the gap and a speed of travel of the device. At operation 912, the system can determine an available of the NTN in the coverage gap. In some implementations, the NTN is a satellite network. In some implementations, the system determines a particular satellite to connect to base on the predicted travel path of the device and the travel paths of the satellites of the satellite network, for example to minimize the number of satellite handovers that occur while the device is within the coverage gap. At operation 914, if the NTN is either not available (or will be available for less than a threshold amount of time or over less than a threshold length along the path of travel), the system can determine that the device should not scan for an NTN at operation 920. When the process runs on a system other than the device, the system can send a notification or other instruction to the device indicating that the device should not scan for an NTN. If the NTN is available and provides adequate coverage within the gap, the system can, at operation 916, determine a scan frequency for attempting to establish a connection with the NTN. At operation 918, the device can scan for the NTN at the determined scan frequency. In some implementations, scanning and connecting to the NTN begins before the device enters the coverage gap, for example, in order to reduce an amount of time without connection. In some implementations, scanning and/or connecting to the NTN begins once the device enters the coverage gap. In some implementations, scanning begins when the user is within a threshold distance of the coverage gap (e.g., a boundary of the coverage gap), which can be either outside the coverage gap or inside the coverage gap. When the process is executed on a system other than the device, the system can provide a notification or other instruction to the device indicating the scan frequency.

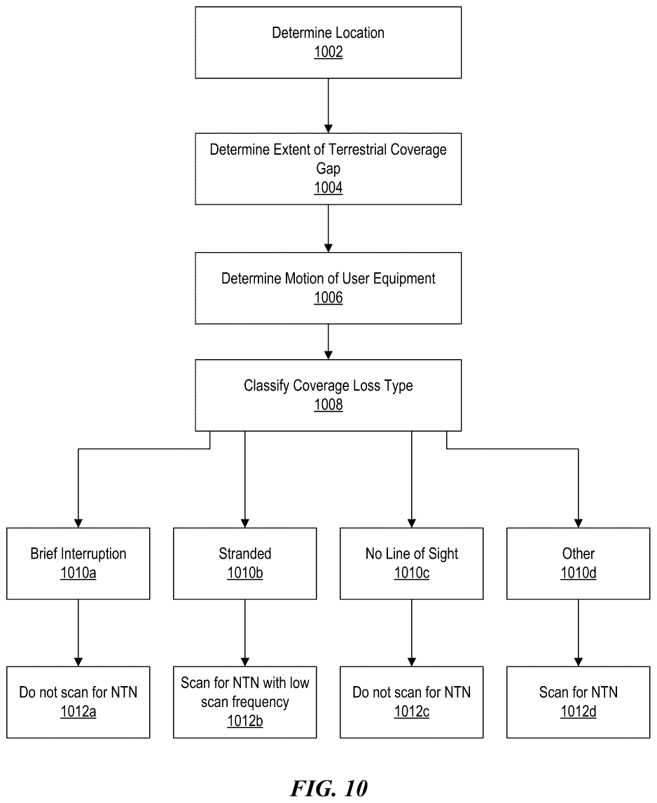

FIG. 10 is a flowchart that illustrates an example process for determining a scanning frequency according to some implementations. At operation 1002, a system can determine a location of a user device such as a smartphone. For example, in some embodiments, the system can determine the location based on location information (e.g., GPS information) provided by the user device. In some implementations, the system determines the location based on information from a wireless telecommunications company, such as signal strength, connected towers, etc. At operation 1004, the system can determine an extend of a terrestrial coverage gap. The extent of the terrestrial coverage gap can be used in determining whether or not to attempt to transition to an NTN. At operation 1006, the system can determine motion of a user equipment such as a smartphone. The motion of the user equipment can indicate whether the user is stationary or moving. In some implementations, the determined motion includes speed. In some implementations, the determined motion includes direction. Direction can be significant because it can be used to determine if a user is moving deeper into an area without terrestrial coverage or is moving towards coverage, can be used to estimate a time the user equipment will be without coverage (e.g., alone or in combination with speed information), etc. At operation 1008, the system can classify a coverage loss type, for example based on the extent of the terrestrial coverage gap and/or the motion of the user equipment.

The classification can fall into several categories. In FIG. 10, four categories are illustrated, but there can be more or fewer categories. In the case of a brief interruption 1010a (e.g., when the user enters a relatively small area where terrestrial coverage is absent or inadequate), the system can determine that the user equipment should not scan for an NTN, as doing so can consume significant resources (e.g., battery life) for little benefit as the user equipment is expected to only be out of a terrestrial coverage area for a short period of time. If the user is stranded 1010b (e.g., the user does not appear to be moving outside of an area for at least a minimum amount of time), the system can determine that the user equipment should scan for an NTN, but should do so with a relatively low scan frequency. For example, if a user is stranded, it can be desirable to attempt to connect to an NTN, but it can also be important to conserve battery life as a user may be unable to recharge their device. In some implementations, mapping information is used in determining if a user is stranded. For example, if a user is not moving for a long time and is located in a remote area, this can indicate that the user is stranded (as opposed to, for example, sleeping while camping). However, if the user is not moving and is located in an urban area, this may not indicate that the user is stranded but could instead indicate, for example, that the user is intentionally spending time in a location with limited or no terrestrial coverage. In some implementations, whether a not a user is stranded is predicted using a machine learning model trained on past location behavior of users. For example, in a remote area, user location data may appear similar for users who are camping at a public campsite and for users who are stranded in the forest, but the model may be able to differentiate between these two scenarios based on prior location behavior that indicates users at the campsite location tend to move back into an area with terrestrial coverage within a certain timeframe. If there is no line of sight 1010c, for example because the user is underground or indoors, the system can determine that a scan frequency 1012c should be set to zero as it is unlikely that the user equipment will be able to connect to an NTN. If the classification is another classification 1010d, the system can determine a scan frequency 1012d. The scan frequency 1012d can include scanning for an NTN at a standard frequency, which can vary depending upon, for example, a charge level of the user equipment.

While FIG. 10 is described with respect to connecting to an NTN when terrestrial coverage is not available, it will be appreciated that the approaches described in FIG. 10 can be readily adapted to other contexts, such as determining whether or not to roam onto another cellular network that does have coverage in the area.

The approach illustrated in FIG. 10 can be carried out on a system under the control of a wireless telecommunications service. For example, a server controlled by the wireless telecommunications service can determine a scan frequency for a user equipment and can communicate the scan frequency to the user equipment. However, such an approach can have some drawbacks, as there is a need for advance planning and communication, since the user equipment may be unable to receive the scan frequency information when it is out of a terrestrial coverage area (although in some cases, the user equipment may be connected to another network, such as a Wi-Fi network, and thus be able to receive the scan frequency information via such network). In some implementations, the approach illustrated in FIG. 10 are implemented on user equipment. For example, user equipment can be provided with coverage information for terrestrial and/or non-terrestrial networks and can perform calculations on-device to determine an appropriate scan frequency. Such an approach can be desirable because scan frequency determinations can be made and used even when a device is not connected to a network.

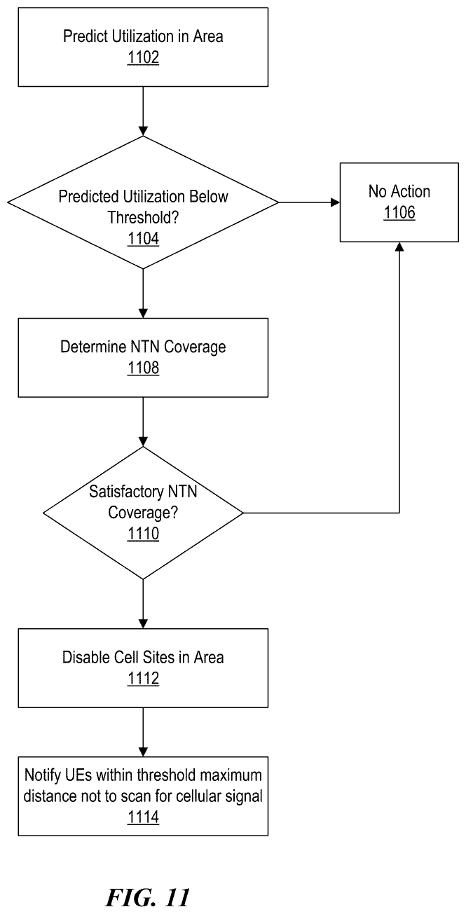

FIG. 11 is a flowchart that illustrates an example process for disabling cell sites in an area according to some implementations. At operation 1106, a system can predict utilization in an area. The predicted utilization can be based on historical utilization information, event information, weather information, and/or any other information that can provide insight into an expected utilization in an area. At operation 1104, if the predicted utilization is not below a threshold, the system can take no action at operation 1106. If the predicted utilization at operation 1104 is below the threshold, the system can, at operation 1108, determine NTN coverage in the area. As described herein, NTNs often use low earth orbit satellites that are not geostationary, and NTN coverage can vary over time. Determining NTN coverage can include, for example, determining whether or not there is NTN coverage, capacity of the NTN coverage in the area, expected outages of NTN coverage in the area, and so forth. For example, if the NTN has no coverage, there are expected to be significant outages or gaps in NTN coverage, or NTN capacity in the area is expected to be too low to adequately support demands, disabling cell sites can have an adverse impact on users. Other NTN types (e.g., balloons, planes, drones, etc.) can similarly provide coverage that varies over time. At operation 1110, if there is not satisfactory NTN coverage, the system can take no action at operation 1106. If, at operation 1110, there is significant NTN coverage, the system can disable one or more cell sites in the area at operation 1112. In some implementations, cell sites are disabled immediately. In some implementations, cell sites are scheduled to be disabled. For example, cell sites in the area can be scheduled to be disabled at a particular time when utilization is expected to drop below the threshold. In some implementations, the system determines a duration for disabling the cell sites. For example, if the predicted utilization is predicted to be below the threshold from 11 PM to 7 AM, the system can disable cell sites in the area at 11 PM and can reactivate the cell sites at 7 AM.

As discussed herein, scanning for cellular coverage can consume significant energy, negatively impacting the battery life of user equipment. At operation 1014, the system can notify user equipment within a threshold maximum distance of the area not to scan for cellular signal within the area, thereby preventing user equipment from scanning for cellular coverage within an area and/or during times when cell sites are disabled in the area.

In some implementations, the process shown in FIG. 10 is conducted for all cell sites in a network. However, doing so can waste computing resources as many cell sites are poor candidates for being temporarily disabled. For example, cell sites in dense urban areas are likely poor candidates for being temporarily disabled as loads can be significant even during off-peak times.

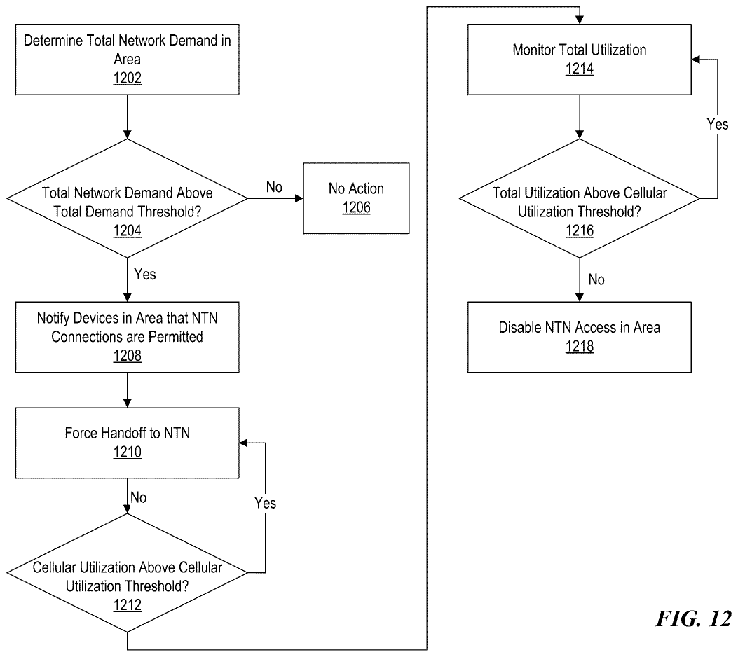

FIG. 12 is a flowchart that illustrates an example process for enabling NTN access in a geofenced area according to some implementations. As described herein, it can be preferable to keep user equipment on a cellular network when there is adequate cellular coverage available. NTN access can be disabled in some areas under normal circumstances. For example, NTN access can be disabled in urban areas where there is typically good cellular coverage and it is desired that devices do not transition to an NTN during periods where cellular coverage is not available, such as when users are underground or in buildings. However, under certain circumstances, it can be desirable to allow connections to an NTN where such connections are not normally permitted. For example, during sporting events, concerts, etc., demand may significantly exceed cellular capacity, in which case an NTN can be used to provide additional capacity.

At operation 1202, a system can evaluate total network demand in an area. Total demand can be evaluated based on, for example, actual utilization of the cellular network in the area, a number of devices connected to the cellular network in the area, a number of devices in proximity to the area, etc. In some implementations, past locations are be used to determine whether a user is likely to remain in an area or not. For example, if a user frequently passes through an area, it can be unlikely that they will remain in the area. If a user rarely visits an area, it can be likely that they are in the area for an event and thus are likely to remain in the area and contribute to network demand. Such information can be used to adjust a current total network demand based on predicted user behavior.

At operation 1204, the system can determine if the total network demand is above a total demand threshold. The total demand threshold can be based on, for example, a maximum utilization or maximum capacity of the cellular network in the area. If the total network demand is not above the total demand threshold, the system can take no action at operation 1206. That is, denial of NTN access in the area can remain in place and devices can remain on the cellular network. If total network demand is above the total demand threshold, the system can permit NTN access in the area and can, at operation, 1208, notify devices (e.g., devices in the area, proximate to the area (e.g., within a threshold distance of the area), etc.) that NTN connections are permitted in the area. At operation 1210, the system can force one or more devices in the area to handoff from the cellular network to the NTN. As described herein, it can be desirable to minimize utilization of the NTN, so not all devices may be handed off to the NTN. At operation 1212, the system can evaluate if cellular utilization is above a cellular utilization threshold, which can be based on a maximum capacity of the cellular network in the area. If, at operation 1212, the cellular utilization is above the cellular utilization threshold, the system can force additional devices to handoff to the NTN. If not, the system can monitor total utilization at operation 1214. The total utilization can include utilization of the cellular network and the NTN. At operation 1216, if the total utilization is above the cellular utilization threshold, the system can continue monitoring total utilization. If the total utilization drops below the cellular threshold, the system can disable NTN access in the area at operation 1218. In some implementations, NTN access in the area is only disabled if total utilization drops below the cellular utilization threshold for at least a threshold amount of time.

### Computer System

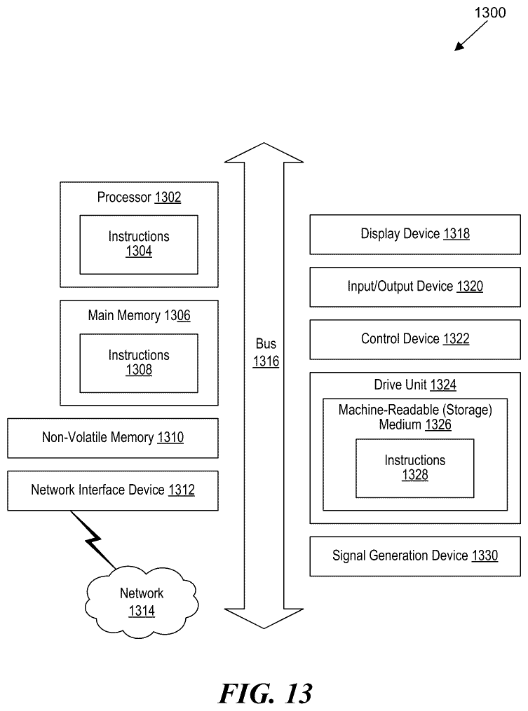

FIG. 13 is a block diagram that illustrates an example of a computer system 1300 in which at least some operations described herein can be implemented. As shown, the computer system 1300 can include: one or more processors 1302, main memory 1306, non-volatile memory 1310, a network interface device 1312, a video display device 1318, an input/output device 1320, a control device 1322 (e.g., keyboard and pointing device), a drive unit 1324 that includes a machine-readable (storage) medium 1326, and a signal generation device 1330 that are communicatively connected to a bus 1316. The bus 1316 represents one or more physical buses and/or point-to-point connections that are connected by appropriate bridges, adapters, or controllers. Various common components (e.g., cache memory) are omitted from FIG. 13 for brevity. Instead, the computer system 1300 is intended to illustrate a hardware device on which components illustrated or described relative to the examples of the figures and any other components described in this specification can be implemented.

The computer system 1300 can take any suitable physical form. For example, the computing system 1300 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1300. In some implementations, the computer system 1300 can be an embedded computer system, a system-on-chip (SOC), a single-board computer system (SBC), or a distributed system such as a mesh of computer systems, or it can include one or more cloud components in one or more networks. Where appropriate, one or more computer systems 1300 can perform operations in real time, in near real time, or in batch mode.

The network interface device 1312 enables the computing system 1300 to mediate data in a network 1314 with an entity that is external to the computing system 1300 through any communication protocol supported by the computing system 1300 and the external entity. Examples of the network interface device 1312 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1306, non-volatile memory 1310, machine-readable medium 1326) can be local, remote, or distributed. Although shown as a single medium, the machine-readable medium 1326 can include multiple media (e.g., a centralized/distributed database and/or associated caches and servers) that store one or more sets of instructions 1328. The machine-readable medium 1326 can include any medium that is capable of storing, encoding, or carrying a set of instructions for execution by the computing system 1300. The machine-readable medium 1326 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1310, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1304, 1308, 1328) set at various times in various memory and storage devices in computing device(s). When read and executed by the processor 1302, the instruction(s) cause the computing system 1300 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A method for regulating access to a non-terrestrial wireless telecommunications network, the method comprising:
determining a terrestrial demand level of a terrestrial wireless telecommunications network in a geographic area;
determining if the non-terrestrial wireless telecommunications network is available in the geographic area; and
when a plurality of conditions comprising at least that the non-terrestrial wireless telecommunications network is available in the geographic area and that the terrestrial demand level exceeds a threshold terrestrial demand level is satisfied:
transmitting a notification to a plurality of user equipment in the geographic area indicating that communications over the non-terrestrial wireless telecommunications network are permitted within the geographic area;
causing a subset of the plurality of user equipment in the geographic area to utilize the non-terrestrial wireless telecommunications network;
when the terrestrial demand level is above the threshold terrestrial demand level after causing the subset of the plurality of user equipment to utilize the non-terrestrial wireless telecommunications network:
causing additional user equipment of the plurality of user equipment to utilize the non-terrestrial wireless telecommunications network; and
when the terrestrial demand level is below the threshold terrestrial demand level:
determining a total demand level, wherein the total demand level comprises the terrestrial demand level and a non-terrestrial demand level; and
disabling access to the non-terrestrial wireless telecommunications network in the geographic area when at least one condition is satisfied, wherein the at least one condition comprises the total demand level being less than the threshold terrestrial demand level.

2. A method for regulating access to a non-terrestrial wireless telecommunications network, the method comprising:
determining a terrestrial demand level of a terrestrial wireless telecommunications network in a geographic area;
determining if the non-terrestrial wireless telecommunications network is available in the geographic area; and
when a plurality of conditions comprising at least that the non-terrestrial wireless telecommunications network is available in the geographic area and that the terrestrial demand level exceeds a first threshold terrestrial demand level is satisfied:
transmitting a notification to a plurality of user equipment in the geographic area indicating that communications over the non-terrestrial wireless telecommunications network are permitted within the geographic area; and
causing at least a portion of the plurality of user equipment in the geographic area to utilize the non-terrestrial wireless telecommunications network.

3. The method of claim 2, further comprising:
predicting, using a machine learning model, a time that the terrestrial demand level will remain above the first threshold terrestrial demand level,
wherein the plurality of conditions further comprises that the time exceeds a minimum threshold, and
wherein the machine learning model is trained using historical demand data to predict demand levels.

4. The method of claim 3, wherein the machine learning model is configured to be applied to input data comprising at least one of location data, weather data, event data, or holiday data, and wherein the historical demand data comprises at least one of location data, weather data, event data, or holiday data.

5. The method of claim 2, wherein the terrestrial wireless telecommunications network comprises a cellular network.

6. The method of claim 2, wherein the non-terrestrial wireless telecommunications network comprises a satellite network.

7. The method of claim 2, wherein the first threshold terrestrial demand level is based at least in part on a capacity of the terrestrial wireless telecommunications network in the geographic area.

8. The method of claim 2, wherein determining if the non-terrestrial wireless telecommunications network is available in the geographic area comprises determining an available capacity of the non-terrestrial wireless telecommunications network.

9. The method of claim 2, wherein determining if the non-terrestrial wireless telecommunications network is available comprises determining a length of time the non-terrestrial wireless telecommunications network is available in the geographic area, wherein the non-terrestrial wireless telecommunications network is determined not to be available if the non-terrestrial wireless telecommunications network is available for less than a minimum amount of time.

10. The method of claim 2, wherein determining that the terrestrial demand level in the geographic area exceeds the first threshold terrestrial demand level comprises determining that the terrestrial demand level in the geographic area exceeds the first threshold terrestrial demand level for at least a minimum length of time.

11. The method of claim 2, further comprising:
when the non-terrestrial wireless telecommunications network is available in the geographic area and the terrestrial demand level is below a second threshold terrestrial demand level:
transmitting a notification to a plurality of user equipment in the geographic area indicating the communications over the non-terrestrial wireless telecommunications network are permitted within the geographic area; and
disabling one or more infrastructure components of the terrestrial wireless telecommunications network, wherein the one or more infrastructure components provide coverage within the geographic area.

12. The method of claim 2, wherein transmitting the notification to the plurality of user equipment in the geographic area further comprises transmitting the notification to a plurality of devices within a threshold distance of the geographic area.

13. A system for regulating access to a non-terrestrial wireless telecommunications network, the system comprising:
at least one hardware processor; and
a non-transitory, computer-readable medium storing instructions that, when executed by the at least one hardware processor, cause the system to:
determine a terrestrial demand level of a terrestrial wireless telecommunications network in a geographic area;
determine if the non-terrestrial wireless telecommunications network is available in the geographic area; and
when the non-terrestrial wireless telecommunications network is available in the geographic area and the terrestrial demand level exceeds a first threshold terrestrial demand level:
transmit a notification to a plurality of user equipment in the geographic area indicating that communications over the non-terrestrial wireless telecommunications network are permitted within the geographic area;
cause a subset of the plurality of user equipment in the geographic area to utilize the non-terrestrial wireless telecommunications network;
when the terrestrial demand level is above the first threshold terrestrial demand level after causing the subset of the plurality of user equipment to utilize the non-terrestrial wireless telecommunications network:
cause additional user equipment of the plurality of user equipment to utilize the non-terrestrial wireless telecommunications network; and
when the terrestrial demand level is below the first threshold terrestrial demand level:
determine a total demand level, wherein the total demand level comprises the terrestrial demand level and a non-terrestrial demand level; and
disable access to the non-terrestrial wireless telecommunications network in the geographic area when at least one condition is satisfied, wherein the at least one condition comprises the total demand level being less than the first threshold terrestrial demand level.

14. The system of claim 13, wherein the terrestrial wireless telecommunications network comprises a cellular network.

15. The system of claim 13, wherein the non-terrestrial wireless telecommunications network comprises a satellite network.

16. The system of claim 13, wherein the first threshold terrestrial demand level is based at least in part on a capacity of the terrestrial wireless telecommunications network in the geographic area.

17. The system of claim 13, wherein determining if the non-terrestrial wireless telecommunications network is available in the geographic area comprises determining an available capacity of the non-terrestrial wireless telecommunications network.

18. The system of claim 13, wherein determining if the non-terrestrial wireless telecommunications network is available comprises determining a length of time the non-terrestrial wireless telecommunications network is available in the geographic area.

19. The system of claim 13, wherein determining that the terrestrial demand level in the geographic area exceeds the first threshold terrestrial demand level comprises determining that the terrestrial demand level in the geographic area exceeds the first threshold terrestrial demand level for at least a minimum length of time.

20. The system of claim 13, wherein the instructions further cause the system to:
when the non-terrestrial wireless telecommunications network is available in the geographic area and the terrestrial demand level is below a second threshold terrestrial demand level:
transmit a notification to a plurality of user equipment in the geographic area indicating the communications over the non-terrestrial wireless telecommunications network are permitted within the geographic area; and
disable one or more infrastructure components of the terrestrial wireless telecommunications network, wherein the one or more infrastructure components provide coverage within the geographic area.
